(19) United States
(12) Patent Application Publication
(10) Pub. No.: US 2025/0263248 A1
(43) Pub. Date: Aug. 21, 2025

(54) CONVEYOR FOR CONTAINER TRANSPORT AND METHOD FOR MONITORING THE CONVEYOR

(71) Applicant: KRONES AG, Neutraubling (DE)

(72) Inventor: Sebastian LANGWIESER, Abensberg (DE)

(21) Appl. No.: 19/057,536

(22) Filed: Feb. 19, 2025

(30) Foreign Application Priority Data
Feb. 19, 2024 (DE) 10 2024 104 482.9

(51) Int. Cl. B65G 43/10

(52) U.S. Cl. CPC B65G 43/10

(57) ABSTRACT

The invention relates, inter alia, to a conveyor for container transport, preferably for can transport, for a container processing facility. The conveyor has a revolving transport element and a plurality of carriers which are attached to the revolving transport element at a distance from one another along the rotating transport element for carrying containers along. The conveyor further comprises a sensor device which is configured to detect the plurality of carriers.

### CROSS-REFERENCE TO RELATED APPLICATIONS

This application claims the benefit under 35 U.S.C. § 119(a) of German Patent Application No. DE 10 2024 104 482.9, filed Feb. 19, 2024, entitled CONVEYOR FOR CONTAINER TRANSPORT AND METHOD FOR MONITORING THE CONVEYOR, and whose entire disclosure is incorporated by reference herein.

### TECHNICAL FIELD

The invention relates to a conveyor for container transport for a container processing facility, and a container processing facility comprising the conveyor. The invention further relates to a method for monitoring a conveyor for container transport for a container processing facility.

### TECHNICAL BACKGROUND

The use of conveyors in a container processing facility in order to transport containers between different machines in the facility is known.

DE 10 2020 116 779 A1 relates to a container processing device, in particular a filling machine for filling cans or similar containers with a liquid filling material. In this case, the container processing device comprises a first conveyor designed as a container infeed, a rotor arranged downstream in the treatment processing direction and rotating around a machine shaft with several processing positions for processing the containers, and a second conveyor arranged downstream of the rotor in the processing direction and designed as a container outlet. In this case, the second conveyor is designed as a chain conveyor which has at least one guide finger on a continuously revolving conveyor means, which finger moves with the conveyor means and has a first and a second guide section which takes over the containers which have been processed at the several treatment positions of the rotor and are not yet closed.

A disadvantage of the known prior art may be that wear monitoring of the conveyor is conventionally only possible during operational breaks and manually by visual inspection or measurement.

The invention is based upon the object of creating an improved technology for wear monitoring for a conveyor, preferably a chain conveyor, of a container processing facility.

### SUMMARY OF THE INVENTION

The object is achieved by the features of the independent claims. Advantageous developments are specified in the dependent claims and the description.

One aspect relates to a (for example, chain) conveyor for container transport, preferably for can transport, for a container processing facility. The conveyor has a revolving transport element, preferably a transport chain. The conveyor further comprises a plurality of (for example, container) carriers which are attached (for example, on one side) to the revolving transport element at a distance from one another along the revolving transport element for carrying containers, preferably one container at a time. The conveyor further comprises a for example, optical) sensor device which is configured to detect the plurality of carriers.

Advantageously, the conveyor can make automatic wear monitoring of the transport element and in particular of the carriers possible. By detecting the carriers, it is possible to check, for example, whether there is a position deviation of one or more carriers, which can be used to determine, for example, an undesirable deformation (for example, due to a collision) of a carrier or an undesirable elongation of the transport element. Wear monitoring can preferably be made possible during production operation, so that no operational breaks are necessary for wear detection. In particular, deformations of individual carriers can be detected immediately, before production of a larger product batch with damaged containers. The information about the state of wear can advantageously be used for maintenance notifications and/or even to automatically adapt the operation of the conveyor to improve container acceptance and/or container transfer under the signs of wear that have already occurred.

In one exemplary embodiment, the sensor device is configured to detect the plurality of carriers one after the other during operation of the conveyor at at least one prespecified (stationary) position, preferably in a drive region and/or in a deflection region, of the conveyor. On the one hand, this can advantageously make monitoring during operation possible. On the other hand, the defined position for detection makes a very high resolution and accuracy of wear monitoring possible. In this case, the position in the drive region can be used particularly advantageously to detect any undesirable deformation of the carriers, since the connections of the carriers in the drive region are determined by the attachment to the transport element and its engagement with a drive pulley or similar. A deformation in or against the transport direction can thus be reliably detected. The position in the deflection region can in turn be used particularly advantageously to detect an undesired elongation of the transport element.

In a further exemplary embodiment, the sensor device is configured to detect the plurality of carriers each time at least one (for example, vertically aligned) signal barrier, preferably a light barrier, of the sensor device is interrupted. This can advantageously make reliable and long-lasting detection possible, even at high conveying speeds.

In one embodiment, the plurality of carriers are configured as cantilever arms attached to the revolving transport element.

In a further embodiment, the sensor device is configured to detect the cantilever arms at a free end of the respective cantilever arm. This advantageously allows reliable detection in particular of deformations of the cantilever arms at their attachment to the transport element.

In one embodiment variant, the conveyor has a drive pulley, preferably a drive pinion, which is drivingly connected to the transport element. The sensor device has a drive region sensor, preferably a (for example, vertically aligned) signal barrier, particularly preferably a light barrier, which is arranged to detect the carriers as they pass the drive pulley, preferably in order to determine a deformation wear state of the respective carrier. As already mentioned, this can advantageously be used to detect undesirable deformation of the carriers, since the connections of the carriers in the drive region are determined by the attachment to the transport element and its engagement with the drive pulley.

In a further embodiment variant, the conveyor has a deflection pulley, preferably a deflection pinion, which is connected to the transport element for deflecting the transport element. The sensor device has a deflection region sensor, preferably a (for example, vertically aligned) signal barrier, particularly preferably a light barrier, which is arranged to detect the carriers as they pass the deflection pulley, preferably in order to determine an elongation wear state of the revolving transport element. As already mentioned, this allows an undesired elongation of the transport element to be reliably detected.

In one exemplary embodiment, the conveyor further comprises an evaluation device which is configured:
to determine the wear state of the conveyor depending on a signal output from the sensor device; and optionally
to operate a (for example, visual, acoustic and/or haptic) output device for outputting the determined wear state and/or to send the determined wear state to a server device and/or to adapt an operation of a drive device of the conveyor to at least partially compensate for the determined wear state.

In a further exemplary embodiment, the evaluation device is configured:
depending on the signal output of the sensor device, to determine a position deviation of the respectively detected carrier between an actual position of the respectively detected carrier, preferably in relation to the revolving transport element, and a target position of the respectively detected carrier, preferably in relation to the revolving transport element; and
to determine the wear state of the conveyor depending on the detected position deviations.

In a further exemplary embodiment, the evaluation device is configured:
to determine a wear state, preferably a deformation wear state, for each of the plurality of carriers individually and identifiably, depending on the position deviation determined in each case; and/or
in the event of a position deviation with the same sign occurring over several consecutive carriers, to determine a wear state, preferably elongation wear state, of the revolving transport element.

In a further embodiment, the evaluation device is configured:
to determine the actual position of the respectively detected carrier depending on the signal output of the sensor device and via a drive control device, preferably a servo converter, of a drive device of the conveyor, particularly preferably the signal output of the sensor device connected to a trigger input of the drive control device; or
to determine the actual position of the respectively detected carrier depending on the signal output of the sensor device and a signal output of a rotary encoder of the conveyor.

A further aspect concerns a container processing facility, preferably a can processing facility. The container processing facility comprises a filling device, preferably a rotary filling device, for filling containers, a closure device, preferably a rotary closing device, for closing the containers, and a conveyor as disclosed herein. The conveyor can be connected to the filling device for receiving the containers from the filling device and/or to the closure device for transferring received containers to the closure device.

Preferably, the drive pulley of the conveyor can be arranged at an end of the conveyor associated with the closure device. Advantageously, the drive region sensor can then be used to monitor wear directly at the highly relevant container transfer point from the conveyor to the closure device, which also makes possible, for example, automatic adjustments of the conveyor operation in order to compensate for wear and improve container transfer.

Preferably, the container processing facility can be configured for controlling the temperature of, producing, cleaning, coating, testing, filling, closing, pasteurizing, labeling, printing, marking, laser marking, and/or packaging containers for liquid or pasty media, preferably beverages, liquid foodstuffs, or products from the pharmaceutical or health-care industry.

For example, the containers can take the form of bottles, cans, canisters, cartons, vials, tubes, etc.

Another aspect relates to a method for monitoring a for example, chain) conveyor for container transport, preferably (for example, beverage) can transport and/or as disclosed herein, for a container processing facility (for example, as disclosed herein). The method comprises operating the conveyor for moving a revolving transport element, preferably a transport chain, of the conveyor together with a plurality of (for example, container) carriers, which are attached (for example, on one side) to the revolving transport element at a distance from one another along the revolving transport element for carrying containers, preferably one container at a time. The method further comprises detecting the plurality of carriers during operation of the conveyor via a (for example, optical) sensor device, preferably one after the other at at least one prespecified (stationary) position, preferably in a transport element drive region and/or in a transport element deflection region, of the conveyor. Advantageously, the method can achieve the same advantages that have already been described with reference to the conveyor. The same applies to the preferred exemplary embodiments of the method.

In one exemplary embodiment, at least one of the following is fulfilled:
the plurality of carriers are each detected when at least one (for example, vertically aligned) signal barrier, preferably a light barrier, of the sensor device is interrupted;
the plurality of carriers are configured as cantilever arms attached to the revolving transport element, and optionally the cantilever arms are detected by the sensor device at a free end of the respective cantilever arm;
the plurality of carriers are detected by a drive region sensor (for example, a signal barrier, particularly preferably a light barrier) when passing a drive pulley of the conveyor, preferably in order to determine a deformation wear state of the respective carrier; and
the plurality of carriers are detected by a deflection region sensor (for example, a signal barrier, particularly preferably a light barrier) when passing a deflection pulley of the conveyor, preferably in order to determine an elongation wear state of the revolving transport element.

In a further exemplary embodiment, the method further comprises, via an evaluation device, determining a wear state of the conveyor depending on the detection of the plurality of carriers, and optionally operating a (for example, visual, acoustic and/or haptic) output device for outputting the determined wear state and/or sending the determined wear state to a server device and/or adapting an operation of a drive device of the conveyor to at least partially compensate for the determined wear state.

Preferably, via the evaluation device, depending on the detection of the plurality of carriers, a position deviation of the respectively detected carrier between an actual position of the respectively detected carrier, preferably in relation to the revolving transport element, and a prespecified target position of the respectively detected carrier, preferably in relation to the revolving transport element, can be determined, and the wear state of the conveyor can be determined depending on the determined position deviations.

Optionally, a wear state, preferably a deformation wear state, can be determined individually and identifiably for each of the plurality of carriers, depending on the position deviation determined in each case. Alternatively or additionally, in the event of a position deviation with the same sign occurring over several consecutive carriers, a wear state, preferably an elongation wear state, of the revolving transport element can be determined. Alternatively or additionally, the actual position of the respectively detected carrier can be determined depending on the signal output of the sensor device and via a drive control device, preferably a servo converter, of a drive device of the conveyor (for example, the signal output of the sensor device is connected to a trigger input of the drive control device) or depending on the signal output of the sensor device and a signal output of a rotary encoder of the conveyor.

Preferably, the term “evaluation device” and/or “control device” can refer to an electronic system (for example, configured as a driver circuit or with microprocessor(s) and data memory) which, depending on the design, can perform control tasks and/or regulation tasks and/or processing tasks. Although the term “control” is used herein, this can also comprise or be understood as “closed-loop control” or “control with feedback” and/or “processing” as appropriate.

The preferred embodiments and features of the invention described above can be combined with one another as desired.

### BRIEF DESCRIPTION OF THE DRAWINGS

Further details and advantages of the invention are described below with reference to the accompanying drawings. In the figures:

FIG. 1 is a schematic view of a container processing facility according to an exemplary embodiment of the present disclosure;

FIG. 2 is a graph by way of example for showing actual positions at desired positions of carriers along a revolving transport element of a conveyor according to an exemplary embodiment of the present disclosure; and

FIG. 3 is a graph by way of example for showing actual positions at desired positions of carriers along a revolving transport element of a conveyor according to an exemplary embodiment of the present disclosure.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EXEMPLARY EMBODIMENTS

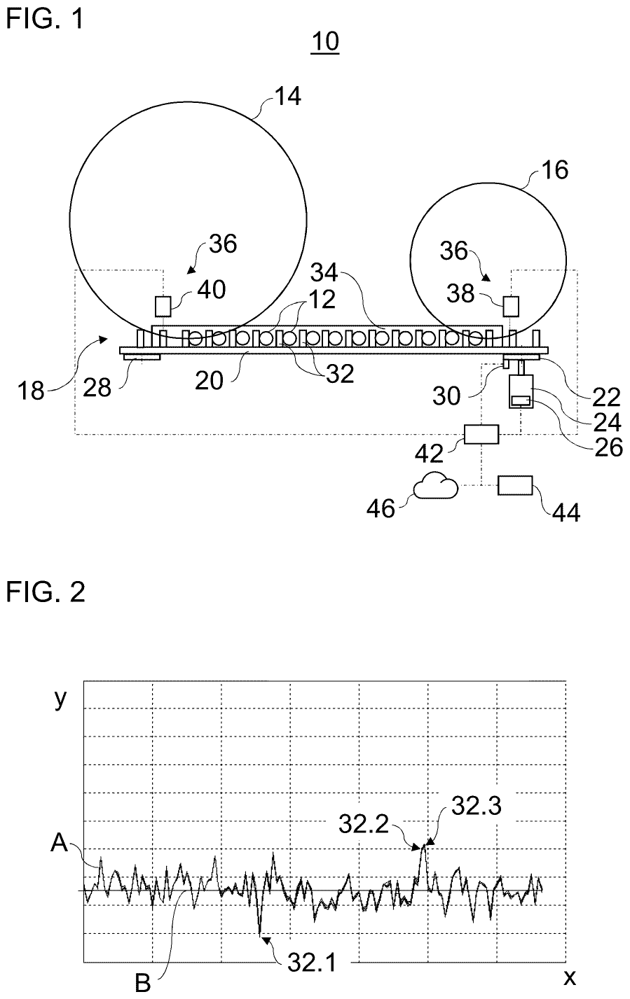

FIG. 1 shows a container processing facility 10 for processing containers 12 (only a few shown in FIG. 1). Preferably, the containers 12 take the form of cans, or the container processing facility 10 is a can processing facility.

The container processing facility 10 has a conveyor 18 for transporting the containers 12. The container processing facility 10 can further comprise, for example, a filling device 14 and/or a closure device 16.

The filling device 14 can fill the containers 12, preferably with a liquid or pasty medium. The filling device 14 is preferably configured as a rotary filling device. The filling device 14 can comprise a plurality of filling valves for filling a plurality of containers 12 simultaneously or overlapping in time. For example, the filling valves can be arranged around a periphery of a filler carousel of the rotary filling device.

The closure device 16 can seal the containers 12, for example with a lid, a cork, a crown cap or a screw cap. The closure device 16 can preferably be configured as a rotary closure device. The closure device 16 can have a plurality of closure stations for closing a plurality of containers 12 either simultaneously or with a temporal overlap. For example, the closure stations can be arranged around a periphery of a closure carousel of the rotary closure device. The closure device can be arranged downstream of the filling device 14 in relation to a container stream.

The conveyor 18 can connect the filling device 14 and the closure device 16 to each other, preferably directly, for transporting containers 12 from the filling device 14 to the closure device 16. The conveyor 18 may be connected to the filling device 14 for receiving containers 12 from the filling device 14, preferably directly. The conveyor 18 can be connected to the closure device 16, preferably directly, for transferring the received containers 12 to the closure device 16.

It is also possible that the conveyor 18 does not take over the containers 12 directly from the filling device 14 but rather for example from an outlet starwheel which is directly connected to the filling device 14. It is also possible that the conveyor 18 does not transfer the containers 12 directly to the closure device 16 but for example to an infeed starwheel which is directly connected to the closure device 16.

The conveyor 18 can have lateral guide rails for laterally guiding the transported containers 12.

The conveyor 18 has a revolving transport element 20, a plurality of (for example, can) carriers 32, and a sensor device 36. The conveyor 18 can, for example, also have a drive pulley 22, a drive device 24, a drive control device 26, a deflection pulley 28, a rotary encoder 30, an evaluation device 42 and/or an output device 44.

The transport element 20 can be a closed transport element or a continuous transport element. The transport element 20 can, for example, rotate around the drive pulley 22 and the deflection pulley 28. Preferably, the transport element 20 is a transport chain. The transport element 20 can transport the containers 12 via the carrier 32.

The drive pulley 22 can be drivingly connected to the revolving transport element 20. For example, the drive pulley 22 can be configured as a drive pinion in engagement with the revolving transport element 20. Preferably, the drive pulley 22 can be a drive sprocket in engagement with the transport element 20 configured as a transport chain.

Preferably, the drive pulley 22 is arranged at an end of the conveyor 18 associated with the closure device 16. Preferably, the containers 12 are transferred from the conveyor 18 to the closure device 16 in the region of the drive pulley 22 or directly adjacent thereto.

The drive device 24 can be drivingly connected to the drive pulley 22. The drive device 24 can preferably be configured as an electric motor. The drive device 24 can, for example, be connected directly or via a transmission to the drive pulley 22 for driving the drive pulley 22.

The drive device 24 may include a drive control device 26 for controlling an operation of the drive device 24. The drive device 26 is preferably configured as a so-called a servo converter. The drive control device 26 can preferably detect a (for example, rotation angle) position of a drive shaft or of a rotor of the drive device 24 and/or a (for example, rotation angle) position of the drive pulley 22 at any time during operation of the drive device 24.

The deflection pulley 28 can be connected to the transport element 20 for deflecting the transport element 20. For example, the deflection pulley 28 can be a deflection pinion in engagement with the revolving transport element 20. Preferably, the deflection pulley 28 can be a deflection sprocket (idler sprocket) in engagement with the transport element 20 configured as a transport chain.

Preferably, the deflection pulley 28 is arranged at an end of the conveyor 18 associated with the filling device 14. Preferably, the containers 12 are transferred from the filling device 14 to the conveyor 18 in the region of the deflection pulley 28 or directly adjacent thereto.

Preferably, the drive pulley 22 and the deflection pulley 28 can be arranged at opposite ends of the conveyor 18.

The optional rotary encoder 30 can detect a rotation angle (a rotation angle position) and output a corresponding rotation angle signal. The rotary encoder 30 can, for example, detect a rotation angle of the drive pulley 22, of a drive shaft of the drive device 24, and/or of a rotor of the drive device 24. The rotary encoder 30 can, for example, be an incremental encoder or an absolute encoder.

The carriers 32 are attached to the revolving transport element 20 spaced apart from one another along the revolving transport element 20 for carrying the containers 12 along. For example, the fastening of the carriers 32 to the transport element 20 can be a detachable fastening, such as a screwed connection. Preferably, the carriers 32 are in each case only attached to one side of the transport element 20. Preferably, each carrier 32 can in each case transport (only) one of the containers 12.

The carriers 32 can be positioned equidistant from each other along the transport element 20. A distance between adjacent carriers 32 can also be referred to as a so-called pitch or a so-called pitch distance (for container transport). The pitch can, for example, be in a range between 70 mm and 110 mm.

The carriers 32 can support the containers 12 at the rear for transport.

For example, the carriers 32 can push the containers 12 over a stationary support surface 34, for example a table, of the conveyor 18. The support surface 34 can preferably extend from the filling device 14 to the closure device 16.

Alternatively, the containers 12 can be supported on the bottom side, for example on a revolving support element, for example a belt or a mat chain, of the conveyor 18, while the containers 12 are each supported on the periphery (lateral face/rear side) by the carriers 32 (not shown in FIG. 1). It is possible that the revolving support element is connected to the transport element 20 for driving via the transport element 20.

Preferably, the carriers 32 can be positioned in the region of the pulling strand (working strand) of the transport element 20, above and vertically spaced apart from the support surface 34 or the revolving support element of the conveyor 18.

Preferably, the carriers 32 can be configured as cantilever arms. The cantilever arms can be attached at one end to the transport element 20, preferably detachably, particularly preferably via a screwed connection. The cantilever arms can span the support surface 34 transversely to the transport direction of the conveyor 18.

For example, the carriers 32 can each have a recess (pocket) for a container 12. The recess can, for example, be in the shape of a cylinder shell segment. The recess can be arranged on a side of the respective carrier 32 facing in the transport direction of the conveyor 18.

The sensor device 36 is configured to detect the plurality of carriers 32. Preferably, the sensor device 36 is an optical sensor device 36.

Preferably, the sensor device 36 can detect the carriers 32 one after the other at at least one prespecified stationary position during operation of the conveyor 18.

A prespecified position can be, for example, in a drive region, for example at the drive pulley 22, of the conveyor 18. Preferably, the sensor device 36 can have a drive region sensor 38. The drive region sensor 38 can be arranged at the drive pulley 22 in order to detect the carriers 32 passing the drive pulley 22.

For example, a longitudinal extension of the drive region sensor 38 in relation to a transport direction/longitudinal axis of the conveyor 18 can overlap with a longitudinal extension of the drive pulley 22 in relation to the transport direction/longitudinal axis of the conveyor 18 or at least be adjacent to one another.

An additionally or alternatively prespecified position can be, for example, in a deflection region, for example at the deflection pulley 28, of the conveyor 18. Preferably, the sensor device 36 can have a deflection region sensor 40. The deflection region sensor 40 can be arranged at the deflection pulley 28 in order to detect the carriers 32 passing the deflection pulley 28.

For example, a longitudinal extension of the deflection region sensor 40 in relation to a transport direction/longitudinal axis of the conveyor 18 can overlap with a longitudinal extension of the deflection pulley 28 in relation to the transport direction/longitudinal axis of the conveyor 18 or at least be adjacent to one another.

Preferably, the sensor 38 and/or 40 can be configured as a signal barrier (signal barrier sensor), preferably a light barrier (light barrier sensor). The respective signal barrier can preferably be oriented vertically. The respective signal barrier can be interrupted (broken) by a carrier 32 passing the respective sensor 38 and/or 40. However, it is also possible that the sensor device 36 or the sensor 38 and/or 40 is based on a different, preferably optical and/or contactless, measuring principle.

Particularly preferably, the sensor device 36 can detect the carriers 32 configured as cantilever arms at a free end of the respective cantilever arm. For example, the sensor 38 and/or 40 can be arranged such that its signal barrier is interrupted by the free end of the respective cantilever arm when passing the sensor 38 and/or 40.

The evaluation device 42 can determine a wear state of the conveyor 18 depending on a signal output of the sensor device 36 or the sensor 38 and/or 40. For this purpose, the evaluation device 42 can preferably determine, depending on the signal output of the sensor device 36, a position deviation of the respectively detected carrier 32 between an actual position of the respectively detected carrier 32, preferably in relation to the revolving transport element 20, and a target position of the respectively detected carrier 32, preferably in relation to the revolving transport element 20.

Depending on the position deviation determined, the wear state of the conveyor 18 can then be determined, for example when a prespecified position deviation tolerance range is exceeded. If, for example, this position deviation is determined in the region of the drive pulley 22, a wear state, preferably a deformation wear state, can be determined individually and identifiably for the plurality of carriers 32, depending on the position deviation determined in each case. If, for example, this position deviation is determined in the region of the deflection pulley 28, then in the case of a position deviation with the same sign occurring over several (for example, three, four, five or more) consecutive carriers 32, a wear state, preferably elongation wear, of the rotating transport element 20 can be determined.

The actual position of the respectively detected carrier 32 can preferably be determined depending on the signal output of the sensor device 36 and via the drive control device 26, preferably a servo converter. Preferably, the signal output of the sensor device 36 (sensor 38 and/or 40) configured as a signal barrier can be connected to a trigger input of the drive control device 26.

Specifically, for example, a carrier 32 can be detected, when passing the drive pulley 22, via the sensor 38 configured as a signal barrier. This signal can be applied to an input of the drive control device 26 configured as a servo converter. When a signal is received from the sensor 38, the servo converter can store and/or output a current drive position, for example a position of the drive shaft or the rotor, of the drive device 24. This position can in turn be converted to an (actual position) within the pitch. Preferably, this also makes it possible to determine the position deviation from the specified pitch (the specified target pitch distance of the carriers 32) or from the end points of this pitch.

Alternatively, it is also possible, for example, to determine the actual position of the respectively detected carrier 32 depending on the signal output of the sensor device 36 and a signal output of the rotary encoder 30.

The output device 44 preferably has a visual display and/or a loudspeaker. The output device 44 can be operated by the evaluation device 42 to output the determined wear state.

The server device 46 is preferably a cloud server device. For example, the server device 46 may be associated with a manufacturer of the filling device 14, of the closure device 16 and/or of the conveyor 18. The evaluation device 42 can send the determined wear state of the conveyor 18 to the server device 46, for example for further evaluation and/or for comparative evaluation with wear states received from other systems for comparable conveyors.

FIG. 2 shows a graph A, purely by way of example, recorded in practice via the sensor 38, which connects the determined relative actual positions (y-axis) of all carriers 32 of a conveyor 18 for adjacent carriers 32 in each case. Graph B shows the prespecified relative target position (y-axis) of the carriers 32, which is the same for all. It can be clearly seen that the actual positions of the carriers 32.1, 32.2 and 32.3 show a comparatively large deviation from the target position. This indicates an undesirable deformation of these carriers 32.1, 32.2 and 32.3.

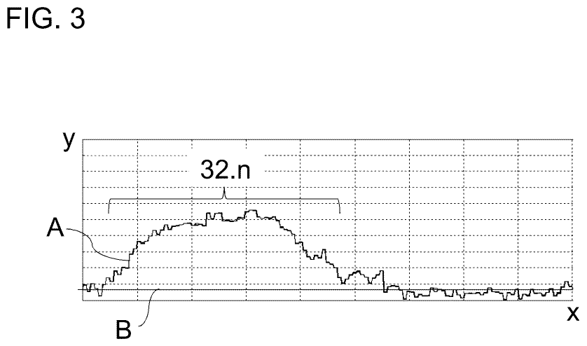

FIG. 3 shows a graph A, purely by way of example, recorded in practice via the sensor 40, which connects the determined relative actual positions (y-axis) of all carriers 32 of a conveyor 18 for adjacent carriers 32 in each case. Graph B again shows the specified relative target position (y-axis) of the carriers 32, which is the same for all. It can be clearly seen that the actual positions of a very large number of neighboring carriers 32.n show a comparatively large deviation from the target position, and this with the same sign. This indicates an undesirable elongation of the transport element 20, for example over several chain links.

The invention is not limited to the preferred embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed independently of all of the features of independent claim 1 and, for example, independently of the features relating to the presence and/or the configuration of the transport element, the carrier and/or the sensor device of independent claim 1. All ranges specified herein are to be understood as disclosed in such a way that all values falling within the relevant range are individually disclosed, for example also as the relevant preferred narrower outer limits of the relevant range.

### LIST OF REFERENCE SIGNS

10 container processing facility
12 container
14 filling device
16 closure device
18 conveyor
20 transport element
22 drive pulley
24 drive device
26 drive control device
28 deflection pulley
30 rotary encoder
32 carrier
34 support surface
36 sensor device
38 drive region sensor
40 deflection region sensor
42 evaluation device
44 output device
46 server device

What is claimed is:

1. A conveyor for container transport for a container processing facility, wherein the conveyor comprises:
a revolving transport element;
a plurality of carriers which are attached to the revolving transport element at a distance from one another along the revolving transport element for carrying containers along; and
a sensor device which is configured to detect the plurality of carriers.

2. The conveyor according to claim 1, wherein:
the sensor device is configured to detect the plurality of carriers one after the other at at least one predetermined position of the conveyor during operation of the conveyor.

3. The conveyor according to claim 1, wherein:
the sensor device is configured to detect the plurality of carriers, in each case upon interruption of at least one signal barrier of the sensor device.

4. The conveyor according to claim 1, wherein:
the plurality of carriers are configured as cantilever arms attached to the revolving transport element.

5. The conveyor according to claim 4, wherein:
the sensor device is configured to detect the cantilever arms at a free end of the respective cantilever arm.

6. The conveyor according to claim 1, wherein:
the conveyor has a drive pulley which is drivingly connected to the transport element; and
the sensor device has a drive region sensor, wherein the drive region sensor is arranged to detect the carriers when as they pass the drive pulley.

7. The conveyor according to claim 1, wherein:
the conveyor has a deflection pulley, which is connected to the transport element for deflecting the transport element; and
the sensor device has a deflection region sensor, which is arranged to detect the carriers as they pass the deflection pulley.

8. The conveyor according to claim 1, wherein at least one of:
the conveyor is for a can transport;
the revolving transport element includes a transport chain;
the plurality of carriers which are attached to the revolving transport element at the distance from one another along the revolving transport element for carrying along one container at a time;
the sensor device is configured to detect the plurality of carriers one after the other at at least one predetermined position in at least one of a drive region and in a deflection region, of the conveyor during operation of the conveyor;
the sensor device is configured to detect the plurality of carriers, in each case upon interruption of at least one light barrier of the sensor device;
the conveyor has a drive pinion, which is drivingly connected to the transport element;
the sensor device has a signal barrier, wherein the drive region sensor is arranged to detect the carriers when as they pass the drive pulley;
the sensor device has a light barrier, wherein the drive region sensor is arranged to detect the carriers when as they pass the drive pulley;
the sensor device has a signal barrier, wherein the drive region sensor is arranged to detect the carriers when as they pass the drive pulley to determine a deformation wear state of the respective carrier;
the conveyor has a deflection pinion which is connected to the transport element for deflecting the transport element;
the sensor device has a signal barrier which is arranged to detect the carriers as they pass the deflection pulley;
the sensor device has a light barrier which is arranged to detect the carriers as they pass the deflection pulley; and
the sensor device has a deflection region sensor which is arranged to detect the carriers as they pass the deflection pulley to determine an elongation wear state of the revolving transport element.

9. The conveyor according to claim 1, further comprising:
an evaluation device that is configured:
to determine a wear state of the conveyor depending on a signal output of the sensor device.

10. The conveyor according to claim 9, wherein:
the evaluation device is configured:
depending on the signal output of the sensor device, to determine a position deviation of the respectively detected carrier between an actual position of the respectively detected carrier, and a target position of the respectively detected carrier; and
to determine the wear state of the conveyor depending on the determined position deviations.

11. The conveyor according to claim 10, wherein:
the evaluation device is configured at least one of:
to determine a wear state for each of the plurality of carriers individually and identifiably, depending on the position deviation determined in each case; and
to determine a wear state of the revolving transport element in the event of a position deviation with the same sign occurring over several consecutive carriers.

12. The conveyor according to claim 10, wherein:
the evaluation device is configured one of:
to determine the actual position of the respectively detected carrier depending on the signal output of the sensor device and via a drive control device of a drive device of the conveyor; and
to determine the actual position of the respectively detected carrier depending on the signal output of the sensor device and a signal output of a rotary encoder of the conveyor.

13. The conveyor according to claim 9, wherein the evaluation device is further configured at least one of:
to operate an output device at least one of for outputting the determined wear state, to send the determined wear state to a server device and to adapt an operation of a drive device of the conveyor in order to at least partially compensate for the determined wear state;
depending on the signal output of the sensor device, to determine a position deviation of the respectively detected carrier between an actual position of the respectively detected carrier and a target position of the respectively detected carrier in relation to the revolving transport element;
depending on the signal output of the sensor device, to determine the position deviation of the respectively detected carrier between an actual position of the respectively detected carrier in relation to the revolving transport element and a target position of the respectively detected carrier;
to determine a deformation wear state for each of the plurality of carriers individually and identifiably, depending on the position deviation determined in each case;
to determine an elongation wear of the revolving transport element in the event of a position deviation with the same sign occurring over several consecutive carriers;
to determine the actual position of the respectively detected carrier depending on the signal output of the sensor device and via a drive control device of a drive device of the conveyor, wherein the signal output of the sensor device is connected to a trigger input of the drive control device; and
to determine the actual position of the respectively detected carrier depending on the signal output of the sensor device and via a servo converter of the drive device of the conveyor.

14. A container processing facility, wherein the container processing facility comprises:
a filling device for filling containers;
a closure device for closing the containers; and
a conveyor according to any of the preceding claims, wherein the conveyor is connected to the filling device for receiving the containers from the filling device, and to the closure device for transferring the received containers to the closure device.

15. The container processing facility according to claim 14, wherein at least one of:
the container processing facility includes a can processing facility;
the filling device includes a rotary filling device; and
the closure device includes a rotary closure device.

16. A method for monitoring a conveyor for container transport for a container processing facility, wherein the method comprises:
operating the conveyor in order to move a revolving transport element of the conveyor together with a plurality of carriers which are attached to the revolving transport element at a distance from one another along the revolving transport element for carrying containers along; and
detecting the plurality of carriers during operation of the conveyor via a sensor device of the conveyor.

17. The method according to claim 16, wherein at least one of the following conditions is met:
the method includes monitoring the conveyor for can transport;
the method includes monitoring the conveyor including a revolving transport element, a plurality of carriers which are attached to the revolving transport element at a distance from one another along the revolving transport element for carrying containers along, and a sensor device which is configured to detect the plurality of carriers;
the revolving transport element includes a transport chain;
the operating the conveyor in order to move the revolving transport element of the conveyor together with the plurality of carriers which are attached to the revolving transport element at the distance from one another along the revolving transport element for carrying along one of the plurality of containers at a time;
the detecting the plurality of carriers during the operation of the conveyor via the sensor device is one after the other at at least one predetermined position of the conveyor;
the detecting the plurality of carriers during the operation of the conveyor via the sensor device at least one of in a transport element drive region and in a transport element deflection region of the conveyor;
the plurality of carriers are each detected when at least one light barrier of the sensor device is interrupted;
the plurality of carriers are configured as cantilever arms attached to the revolving transport element and the cantilever arms are detected by the sensor device at a free end of the respective cantilever arm;
the plurality of carriers are detected by a drive region sensor as they pass a drive pulley of the conveyor for determining a deformation wear state of the respective carrier; and
the plurality of carriers are detected by a deflection region sensor as they pass a deflection pulley of the conveyor for determining an elongation wear state of the revolving transport element.

18. The method according to claim 16, wherein at least one of the following conditions is met:
the plurality of carriers are each detected when at least one signal barrier of the sensor device is interrupted;
the plurality of carriers are configured as cantilever arms attached to the revolving transport element;
the plurality of carriers are detected by a drive region sensor as they pass a drive pulley of the conveyor; and
the plurality of carriers are detected by a deflection region sensor as they pass a deflection pulley of the conveyor.

19. The method according to claim 16, further comprising:
via an evaluation device, determining a wear state of the conveyor depending on the detection of the plurality of carriers.

20. The method according to claim 19, further comprising at least one of:
operating an output device for at least one of outputting the determined wear state, sending the determined wear state to a server device, and adapting an operation of a drive device of the conveyor to at least partially compensate for the determined wear state;
via the evaluation device, depending on the detection of the plurality of carriers, a position deviation of the respectively detected carrier between an actual position of the respectively detected carrier with respect to the revolving transport element and a prespecified target position of the respectively detected carrier is determined and the wear state of the conveyor is determined depending on the determined position deviations;
via the evaluation device, depending on the detection of the plurality of carriers, a position deviation of the respectively detected carrier between an actual position of the respectively detected carrier and a prespecified target position of the respectively detected carrier with respect to the revolving transport element is determined and the wear state of the conveyor is determined depending on the determined position deviations;
for each of the plurality of carriers a wear state is determined individually and identifiably depending on the position deviation determined in each case;
for each of the plurality of carriers a deformation wear state is determined depending on the position deviation determined in each case;
in the case of a position deviation with the same sign occurring over several consecutive carriers, a wear state of the revolving transport element is determined;
in the case of the position deviation with the same sign occurring over several consecutive carriers, an elongation wear state is determined;
the actual position of the respectively detected carrier is determined depending on the signal output of the sensor device and via a drive control device or depending on the signal output of the sensor device and a signal output of a rotary encoder of the conveyor; and
the actual position of the respectively detected carrier is determined depending on the signal output of the sensor device and via one of a servo converter and a drive device of the conveyor or depending on the signal output of the sensor device and a signal output of a rotary encoder of the conveyor.
